(19) United States
(12) Patent Application Publication
(10) Pub. No.: US 2010/0251325 A1
(43) Pub. Date: Sep. 30, 2010

(54) SYSTEM ND METHOD FOR DIALING 911 FROM A TV REMOTE

(75) Inventor: Shekhar Gupta, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/412,214

(22) Filed: Mar. 26, 2009

(51) Int. Cl. H04N 7/173; H04M 11/04; H04N 5/44

(52) U.S. Cl. 725/133; 379/45; 348/734; 348/E05.096

(57) ABSTRACT

A system and method for communicating emergency communications from a set top box to emergency services may be provided, wherein the system and method include receiving a request to contact emergency services using a set top box. The request may come from a remote control or from the set top box itself. Emergency communications may further be communicated to emergency services.

### BACKGROUND OF THE INVENTION

When an emergency occurs and assistance is needed, people have become accustomed to dialing 911 (or a similar emergency number) to request emergency services. Presently, either land-based or cellular communications may be used to contact a 911 operator. More recently, plans to allow for text messaging or other written communications have been provided in some cities, although written communications with 911 remains widely unused in most locations. Communications with 911, in almost all cases, is still currently limited to either a land-based telephone, or a wireless-based communications device, such as a cellular telephone or PDA.

Providing location information to a Public Safety Answering Point (PSAP) remains an important issue, regardless of the communications method used. Even if a person is unable to provide location information verbally, most 911 systems are able to determine location information based upon caller ID information from a land-based telephone, GPS, or cellular coordinate information from a wireless-based communications device. Presently, some type of telecommunications device is necessary in order to communicate with 911, leaving people without a land-based or cellular-based communications device without a way to directly contact emergency services, such as 911.

### BRIEF SUMMARY OF THE INVENTION

In order to provide a person with the ability to contact emergency services, such as 911, without using a land-based or wireless-based telephone, a system and method has been created using a set top box configured to communicate with emergency services. In one embodiment, the set top box may be modified to include a microphone and speaker to allow for audio communications. In another embodiment, the set top box may be modified to include a memory for storing written and/or audio messages for communications to emergency services. In an additional embodiment, a remote control for the set top box may also be modified to initiate communications with emergency services, remotely from the set top box. Using information stored within the set top box or from network data, (such as caller ID information or IP address information), location information may be communicated from the set top box to emergency services.

In one embodiment of the present invention, a system and method for communicating emergency communications from a set top box to emergency services may be provided, wherein the system and method includes receiving a request to contact emergency services using a set top box. The request may come from a remote control or from the set top box itself. Emergency communications may further be communicated to emergency services.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of one embodiment of an environment operable to communicate with emergency services using a set top box, consistent with the present invention;

FIG. 2 is one embodiment of a timing diagram for communicating emergency communications with emergency services;

FIG. 3 is a block diagram depicting components of one embodiment of a set top box operable to provide emergency communications to emergency services consistent with the present invention;

FIG. 4A depicts an illustration of one embodiment of a remote control consistent with the present invention;

FIG. 4B depicts components of one embodiment of a remote control consistent with the present invention;

FIG. 5 is a block diagram of one embodiment of modules configured to communicate with emergency services using a set top box, consistent with the present invention; and

FIG. 6 is a flowchart of one embodiment of a method for communicating emergency communications from a set top box to emergency services.

### DETAILED DESCRIPTION OF THE INVENTION

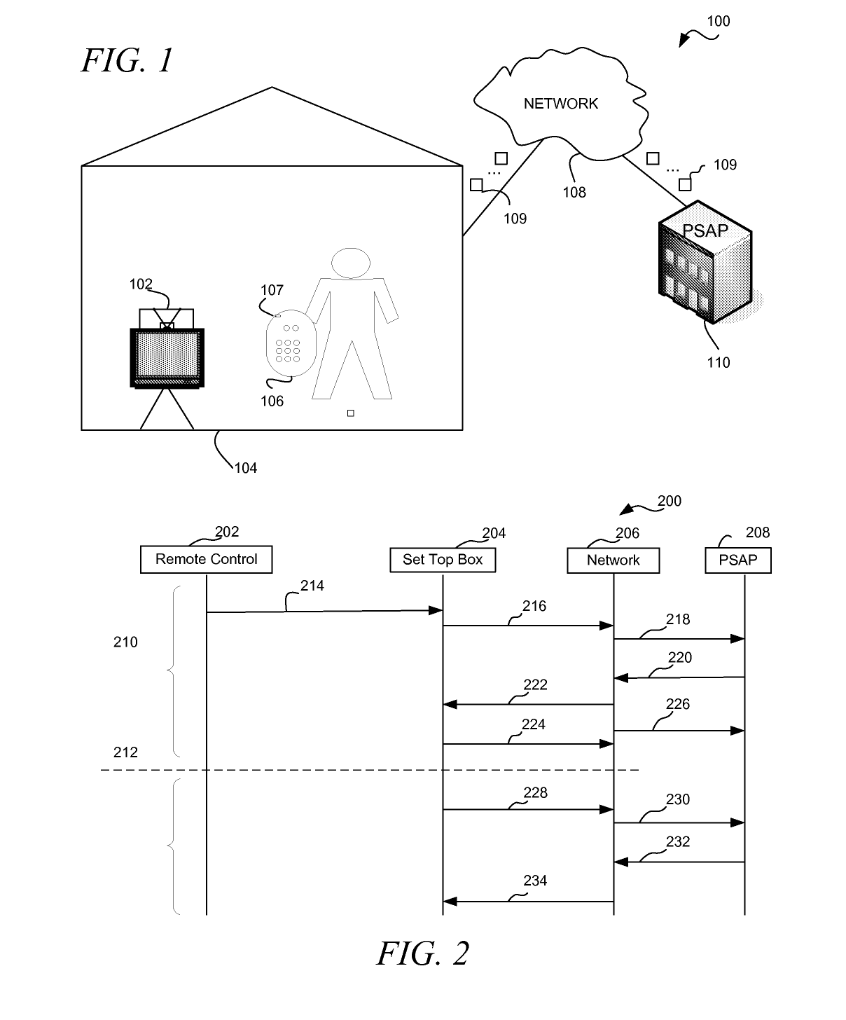

FIG. 1 is an illustration of one embodiment of an environment 100 operable to communicate with emergency services using a set top box. In one embodiment, a set top box 102 may be located within a user location 104 and used primarily for controlling a television set. The set top box 102 may be controlled by a remote control 106, and in one embodiment, the remote control 106 may include an emergency request button 107. The set top box 102 may communicate emergency communications data 109 over a communications network 108 to a public safety answering point (PSAP) 110 or other emergency services facility.

In one embodiment, the set top box 102 may be a traditional cable or satellite receiver that receives a signal from a service provider, such as television or music. The set top box 102 may be modified to include the ability to communicate over a communications network, such as the communications network 108. Modifications may allow the set top box 102 to communicate over a public safety telephone network (PSTN), a wireless network, the Internet, a cable service, or any number of other communications networks. In one embodiment, the set top box 102 may be modified to include a camera that, when activated, allows video or still images to be streamed to a PSAP, recorded locally, or recorded/streamed anywhere within the communications network 108.

A user location 104 may be a residence, such as a house or apartment, an office building, a business, or any number of other locations where a user may want to watch television. The remote control 106 may function as a traditional remote control (i.e., changes the channel, changes the volume, powers a device on and off, selects an input, or any other number of traditional remote control functions.) In addition, the emergency request button 107 may send a signal requesting the set top box 102 to contact emergency services, such as 911. In an alternative embodiment, the remote control 106 may contain more than one emergency request button 107. In this embodiment, each emergency request button 107 may be representative of a particular type of emergency (e.g., fire, medical, or police).

Alternatively, in another embodiment, the remote control 106 may not include a dedicated emergency request button 107. When there is no dedicated emergency request button 107 present, a user may select a combination or pattern of keys, which would initiate an emergency request, a user may select a multi-purpose button that is user programmable, to represent an emergency request button 107, or any number of other variations involving preexisting keys.

In another embodiment, the remote control 106 may additionally include a microphone operable to allow audio input to be communicated to the set top box 102. By including a microphone within the remote control 106, a user may speak directly into the remote control rather than to a microphone located within the set top box 102, or elsewhere, within communication with the set top box 102.

In one embodiment, an alert, such as a flashing screen or a message, may be displayed on a screen of a monitor or television indicating that a request to contact emergency services has been received by the set top box 102. Additionally, or alternatively, a message may be displayed requesting an additional user input, such as a request to press the emergency request button again, or some other method for verifying an emergency request is actually intended. In other embodiments, the emergency request button 107 may be covered by a flap or some other cover which may need to be removed in order to press the emergency request button 107. Other embodiments may include a more deeply recessed button, or a button which needs to be pressed in a different manner, such as a pattern or for a continuous amount of time, in order to activate the emergency request button 107. By providing a check or verification on whether the user intends to contact emergency services, it is more likely that false alarms would not be reported.

The communications network 108 may be a PSTN, cable network, the Internet, satellite network, or any other type of communications network 108 operable to communicate emergency communications 109 to a PSAP 110. Depending on a particular network type, the emergency communications 109 may be data packets in whatever form the communications network 108 is configured to communicate (e.g., analog for PSTN, IP packet data for Internet, etc.) In one embodiment, location information may be communicated to the PSAP 110. Location information may be determined based on user profile information entered into the set top box 102 or user profile information available to a service provider providing the communications network service. In other embodiments, a network address may be used to determine location information to be communicated to the PSAP 110. Location information is an address; however, alternatively, location information may be, or include, a floor of a building, a cubicle, an intersection, a map, directions from a major intersection, or any other similar information.

For example, in one embodiment a user may plug a set top box 102 into an electrical outlet and connect the set top box 102 to the communications network 108. The set top box 102 may be configured to contact a service provider, or a network address independent of the service provider, that is able to provide the set top box 102 with location information. Using information stored within the set top box 102 or provided by the user, location information 109 may be acquired or determined, and stored within the set top box 102. Upon activation of the emergency request button 107, location information may then be available for communication to a PSAP 110 or other emergency service provider.

In one embodiment, the set top box 102 may access a website, such as Google Maps, Mapquest, or a similar provider, via the communications network 108, to determine a route from the PSAP to the location of the set top box 102. A map and/or the route may be additionally communicated to the PSAP 110 during the call, or once the call is completed.

In another embodiment, in addition to communicating location information 109 to a PSAP 110 or other emergency service provider, a secondary notification may be communicated to members of a Network Address Book (NAB) or a similar emergency contact list. The NAB may be located within the set top box 102, or in communication with the set top box 102 via the network 108, and contain a listing of names and contact information for people whom a user wishes to be notified in the event a request for emergency services is made. Alternatively, members listed in the NAB may be contacted upon request of either the PSAP or the user of the set top box 102. By providing an additional notification, family members, next of kin, or any other person that is important to the person requesting help may become automatically notified that an emergency has occurred. It may not always be desirable for a secondary notification to be delivered, therefore the option to contact a secondary party may be disabled by a user of the set top box 102.

A PSAP 110 may be located anywhere within the communications network 108 or in communication with the communications network 108, and provides a calling center for emergency services, such as fire, ambulance, or police. Some PSAPs are able to receive calls, as well as text messages or electronic mail (email). However, other PSAPs are only configured to receive telephone calls from a telephone network, whether the network is land based, cellular based, or otherwise. In one embodiment, an appropriate PSAP may be determined using location information provided by the set top box. Determining an appropriate PSAP may be based not only on location, but on PSAP capabilities as well. For example, if a PSAP is enabled to receive a voice communication routed from the set top box or streaming video, the emergency communication may be routed to that PSAP, if it is determined to be appropriate. Location information may be especially important when a set top box is communicating over the Internet or via a cellular network, and the cellular device is not GPS enabled.

FIG. 2 is one embodiment of a timing diagram 200 for communicating emergency communications with emergency services. In this embodiment, a remote control 202 may communicate with a set top box 204 over a network 206 to a PSAP 208. FIG. 2 describes a remote control initiated sequence 210, as well as a set top box initiated sequence 212.

In the remote control initiated sequence 210, a request may be communicated from the remote control 202 to the set top box 204 in step 214. In step 216, the set top box 204 may communicate emergency communications to a network 206. In step 218, the network 206 communicates the emergency communications to the PSAP 208. The PSAP 208 may respond, in step 220, to the network 206. The network 206 may respond to the set top box 204 in step 222. In step 224, the set top box 204 may return additional communications to the network 206, which the network 206 then communicates to the PSAP 208 in step 226.

Example communications for the remote control initiated sequence may include a voice request for help, a text request for help, or a text request that is converted to speech at the PSAP 208 or somewhere along the network 206, in order for a PSAP 208 without text capabilities to receive the message from the set top box 204. In one embodiment, the set top box 204 may include both a microphone and a speaker. In such an embodiment, a signal from the remote control 202 to the set top box 204 alerts the set top box 204 to initiate communications with the PSAP 208. With both a microphone and a speaker, a user may be able to speak directly to an operator located at the PSAP 208, as if using a speaker phone. In another embodiment, the signal 214 sent from the remote control 202 to the set top box 204 may initiate the sending of a text request to the PSAP, which may either be received by the PSAP as a text or be converted to voice, as described previously.

Additional communications may include location information, for providing the location of the set top box. If a user has entered in address information using a set up screen or the address information is able to be obtained from account information provided by a service provider, this data may be sent to the PSAP along with an emergency communication. In another embodiment, Global Positioning System (GPS) information may be provided if GPS capability is integrated into the set top box or a cellular phone communicating the request over the network. In one embodiment, automatic provisioning, upon plugging the set top box into the network, may determine where the set top box is connected to the network (i.e., network node, etc.) Using information obtained from the automatic provisioning, a service provider may be able to convert the automatic provisioning information to an address or other location description, such as those described previously (e.g., intersection, floor of a building, etc.) Based upon where a set top box is plugged into a network, location information and other geographic information may be determined.

The set top box initiated sequence 212 may include a request, at step 228, that is initiated at the set top box 204, to be sent over the network 206. The main difference between the remote control initiated sequence 210 and the set top box initiated sequence 212 is that no remote control is used in this embodiment. In one embodiment, one or more buttons or other manners for initiating the communication from the set top box 204, such as a menu selection or other command, may be provided. The network 206 may communicate, in step 230, to the PSAP 208 that an emergency services request has been sent. In step 232, the PSAP may communicate back to the network 206 that the emergency services request was received. The network 206 may reply in step 234 to the set top box 204 with a response, or another indication, that the emergency communications was received by the PSAP 208.

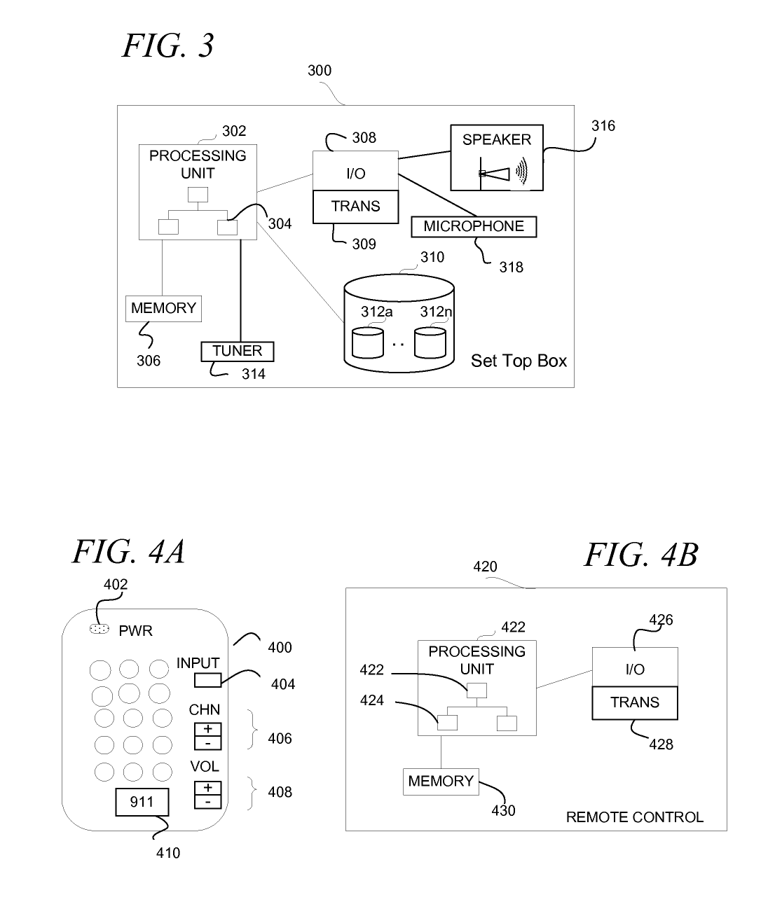

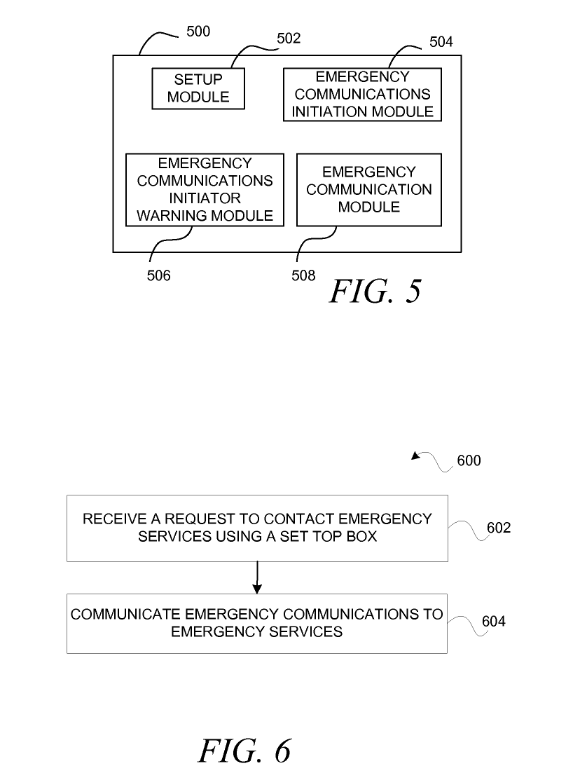

FIG. 3 is a block diagram depicting components of one embodiment of a set top box 300 operable to provide emergency communications to emergency services consistent with the present invention. The set top box 300 may include a processor 302 for processing and accessing communication data, accessing stored entertainment, as well as controlling television functionality. The processor 302 may execute software 304 operable to perform functionality of the set top box 300, including emergency communications notification. Software modules that operate in the software 304 are described below in more detail in reference to FIG. 5.

Memory 306 may also be located within the set top box 300 for storing data being processed by the processor 302. The set top box 300 may include an input/output I/O) unit 308 for receiving and communicating voice and other data, as well as signals from a remote control (not shown.) The I/O unit 308 may additionally include a transceiver 309 for transmitting voice and data over a communications network.

A data storage unit 310 may be included in, or be in communication with, the set top box 300. The data storage unit 310 may be a hard drive or any other type of volatile or non-volatile memory capable of storing data. Within the data storage unit 310 may be one or more data repositories 312a-312n (312), such as a database or multiple databases, capable of storing and organizing data. Some example data may television content, music, a channel selection guide, but any information may be stored within the data repositories 312. In one embodiment, rather than including the data storage unit 310, the set top box 300 may use a memory 306 that is large enough to store any necessary data.

A tuner 314 may be provided within the set top box 300 for controlling a channel or other video input, as would traditionally be performed by a set top box 300. In one embodiment, a speaker 316 and a microphone 318 may additionally be included. By providing a speaker 316, if a telephonic connection is made with an operator located at a PSAP, a user of the set top box 300 is able to hear audio communications from the operator. Alternatively, sound may be transmitted to a monitor or television connected to the set top box, rather than a speaker 316. By including a microphone 318, the user of the set to box 300 may be able to respond audibly, as well. In an alternative embodiment, the speaker 316 and microphone 318 may not be present, and other methods of communication, including stored text data, may be used. In one embodiment a GPS component may also be included (not shown). By having the ability to determine coordinates for the set top box, location information may be communicated to the PSAP in order to help locate the emergency. GPS coordinates are particularly useful when communicating over a network, such as the Internet and cellular, where address information may not be provided by a service provider.

FIG. 4A depicts an illustration of one embodiment of a remote control 400 consistent with the present invention. In one embodiment, the remote control 400 may include buttons that are traditionally found on a remote control. For example, a power button 402 may be provided for turning on and off the set top box. An input selection button 404 may also be provided for selecting an input to be displayed on a monitor or TV, using the set top box. Additionally, channel control buttons 406 and volume control buttons 408 for controlling the channel and volume of the set top box may additionally be provided.

An emergency request button 410 may additionally be provided in order to initiate a request for emergency services over the network to a PSAP. The emergency request button may be hidden, recessed, activated by a particular sequence or force, or any other way to distinguish the emergency request button 410 from a traditional button located on the remote control 400. By activating the emergency request button 410, a request for emergency services may be sent from anywhere within range of the set top box by a user operating the remote control 400. In the event that a user is unable to reach a phone or does not have a phone, the ability to request emergency services by a button, such as the emergency request button 410 may prove invaluable to the user. In an alternative embodiment, rather than, or in addition to, including the emergency request button 410 on a remote control 400, the emergency request button may be located directly on a set top box and activated without using the remote control 400. In another alternative embodiment, the remote control 400 may include multiple emergency request buttons (not shown.)

FIG. 4B depicts components of one embodiment of a remote control 420 consistent with the present invention. The remote control 420 may include a processor 422 for processing channel selection, input selection, volume control, and other traditional remote control functions. The remote control 420, in one embodiment, may additionally include an emergency request button, where the processor 422 is able to process the emergency communications request. The processor 422 may execute software 424 operable to perform functionality of the remote control 420, including initiating an emergency communications request. Memory 430 may also be located within the remote control 420 for storing data being processed by the remote control, specific signals depending upon the button depressed, or any other information necessary to be stored by the remote control 420. The remote control 420 may include an input/output (I/O) unit 426 for communicating data between the remote control 420 and a set top box. The I/O unit 426 may additionally include a transceiver 428 for transmitting data to the set top box.

FIG. 5 is a block diagram of one embodiment of modules 500 configured to communicate with emergency services using a set top box, consistent with the present invention. A setup module 502 may be provided for controlling the initiation and entry of information relating to the set top box. Example information may include an address for the location where the set top box is located, default emergency messages, programming information, and any other information which may be useable by the set top box. In one embodiment, individual pre-stored messages may be recorded indicating a fire emergency, a police emergency, or a medical emergency. In the event that a remote control or the set top box has multiple buttons representing emergency types, or if a menu is activated by either the remote control or the set top box, the various pre-recorded messages may be linked to a particular button, allowing specific information to be automatically communicated to a PSAP. The setup module 502 may additionally allow preferences to be entered by the user setting up network settings, an emergency number to dial, address information, if not readily attainable, as well as any other information which may be useful in the event of an emergency.

An emergency communications initiation module 504 may additionally be provided within the set top box. The emergency communications initiation module 504 may be operable to recognize that an emergency communications request is being received, interpret the request, and allow for the emergency communications request to be communicated to a PSAP. Additionally, the emergency communications initiation module 504, in one embodiment, may activate a speaker phone interface that allows a user to communicate with an operator of a PSAP directly as if speaking over a speaker phone. Various other features may be available depending upon the functionality of the set top box, as well as the functionality of the remote control.

Upon initiation of an emergency communication request, an emergency communications initiator warning module 506 may be used to provide notice to a user of the set top box that a request for emergency services has been received by the set top box. Some examples of a warning may include: a television connected to the set top box muting, a warning message being displayed, a screen on a television or monitor connected to the set top box may flash, noises or other alerts may be provided from the set top box or remote control, or any number of other warnings which may be able to be communicated to a user by either the set top box or remote control. In the event that the user does not intend for the emergency communication request to be communicated to emergency services, an option may be provided to allow the user to cancel the request.

An emergency communication module 508, in the event the emergency services are indeed needed, may be provided to allow the emergency services request to be communicated to a PSAP. In one embodiment, the emergency communication module 508 may set up a call with the PSAP, wherein a user may be able to communicate directly with an operator using functionality described previously, such as the speaker and a microphone located within either the set top box or the remote control. In another embodiment, emergency communication module 508 may send a pre-recorded message. The pre-recorded message may be in audio or text format. In addition, in one embodiment, the pre-recorded messages may be selected and tailored to a specific emergency, as also previously described.

In one embodiment, the emergency communication module 508 may additionally include the ability for the set top box to activate a feed coming from a video camera or other device which may be included within the set top box allowing for a PSAP to receive video of whatever the camera is able to capture. In one embodiment, the video feed may be forwarded to a hospital or first responder to allow monitoring of an emergency, communication with a victim, remote diagnosis, and advice regarding first aid or self treatment. In an alternative embodiment, if the streaming is not able to be received by PSAP, the emergency communication module 508 may initiate a recording of any attached camera or microphone devices to be recorded within the set top box itself, or streamed to a separate network location in communication with the set top box for storage or other displaying.

FIG. 6 is a flowchart of one embodiment of a method 600 for communicating emergency communications from a set top box to emergency services. In step 602, a request to contact emergency services using a set top box may be received. The request may have generated from a remote control or may have been generated from the set top box itself. In step 604, emergency communications may be communicated through emergency services. Emergency services may included a local alarm company, a PSAP, or any other emergency services configured to receive requests for emergency services from the set top box. Emergency communications may include an actual phone call, pre-recorded messages, either audio or text, an email, or any other type of communication in which emergency services is configured to receive.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A set top box for communicating emergency communications with emergency services, the set top box comprising:
a memory component operable to store computer executable instructions;
an input/output unit operable to communicate data associated with the emergency communications;
a processing unit operable to execute the computer executable instructions, said processing unit configured to:
receive a request to contact emergency services using the set top box; and
communicating emergency communications to emergency services.

2. The set top box according to claim 1, wherein the processing unit is further configured to determine location information of the set top box.

3. The set top box according to claim 2, wherein the processing unit is further configured to communicate the location information to emergency services.

4. The set top box according to claim 2, wherein the processing unit, in determining location information, is configured to determine an address in which the set top box is registered with a service provider.

5. The set top box according to claim 1, wherein the processing unit, in receiving a request to contact emergency services, is further configured to receive a request from a remote control modified to include an emergency services button.

6. The set top box according to box of claim 1, wherein the processing unit, in communicating emergency communications, is further configured to communicate a pre-recorded message.

7. The set top box according to claim 1, wherein the processing unit, in communicating emergency communications, is further configured to initiate a telephone call for real-time conversation using the set top box.

8. The set to box according to claim 1, further comprising a microphone operable to receive audio.

9. A method for communicating emergency communications from a set top box to emergency services, said method comprising:
receiving a request to contact emergency services using a set top box; and
communicating emergency communications to emergency services.

10. The method according to claim 9, further comprising determining location information of the set top box.

11. The method according to claim 10, further comprising communicating location information to emergency services.

12. The method according to claim 10, wherein determining location information includes determining an address in which the set top box is registered with a service provider.

13. The method according to claim 9, wherein receiving a request to contact emergency services includes receiving a request from a remote control modified to include an emergency services button.

14. The method according to claim 9, wherein communicating emergency communications includes communicating a pre-recorded message.

15. The method according to claim 9, wherein communicating emergency communications further comprises initiating a telephone call for real-time conversation over the set to box.

16. A remote control for controlling a set top box, the remote control comprising:
a memory component for storing executable instructions;
an input/output unit for receiving requests from buttons on the remote control and transmitting corresponding executable instructions to the set top box;
an emergency communications initiation button; and
a processing unit for communicating the executable instructions to the set top box.

17. The remote control according to claim 16, wherein the processing unit is further configured to request confirmation that emergency services is meant to be contacted, prior to contacting emergency services.

18. The remote control according to claim 16, further comprising one or more additional emergency communications initiation buttons.

19. The remote control according to claim 16, further comprising a microphone operable to record an emergency message.

20. The remote control according to claim 16, wherein the processing unit, in storing executable instructions, stores an executable instruction to turn on a video camera in the set top box.
